(19) United States
(12) Patent Application Publication
(10) Pub. No.: US 2007/0130209 A1
(43) Pub. Date: Jun. 7, 2007

(54) System and method for generating consumer relational marketing information in a system for the distribution of digital content

(76) Inventors: David Marples, Mansfield (GB); Stanley Moyer, Mendham, NJ (US); Chris Drake, Basking Ridge, NJ (US)

Correspondence Address: TELCORDIA TECHNOLOGIES, INC., ONE TELCORDIA DRIVE 5G116, PISCATAWAY, NJ, 08854-4157, US

(21) Appl. No.: 11/592,868

(22) Filed: Nov. 3, 2006

Related U.S. Application Data
(60) Provisional application No. 60/732,930, filed on Nov. 3, 2005.

(51) Int. Cl. G06F 17/00

(52) U.S. Cl. 707/104.1

(57) ABSTRACT

This invention uses the ability to generate consumer relational marketing information from a database of transaction for digital content using a digital content mediator (“DCM”) to track the distribution of digital content. By using information from the transaction log, which can be either generated directly by the DCM server (typically sent to the payment engine for billing purposes) or can be output by the payment engine and combining with information from the content description database, a customer-content history database is created. Data Mining techniques can then be used to dervie the desired consumer relational marketing information from the customer-content history database. However, it is also possible to use data mining techniques across the databases (transaction log, content description database, and (optionally) the customer/client info DB) to obtain the desired consumer relational marketing data without first combining information into the customer-content history database.

### CROSS REFERENCE TO RELATED APPLICATION

This application claims the benefit of U.S. Provisional Patent Application No. 60/732,930, filed Nov. 3, 2005, the disclosure of which is hereby incorporated herein by reference.

### FIELD OF THE INVENTION

The present invention relates generally to the field of digital content distribution in a network and methods and systems generating and utilizing consumer relational marketing information from transactions involving the distribution of digital content.

### BACKGROUND OF THE INVENTION

As digital content transactions are relatively new to the marketplace, not much motivation has existed to develop techniques to derive consumer relational marketing data. However, there are serveral products and technologies that currently perform Consumer Relational Marketing (“CRM”) these days, but in ways that are very different than proposed in this invention. For example Columbia House has a great affinity tracking program, and Amazon.com has technology that can recommend additional/new purchases based on past purchases and similar buying behavior. The Nielsen family of companies like Nielsen Media Research and Nielsen NetRatings employ a combination of activity monitoring technology with surveys to better understand consumer behavior, but most of that technology requires a lot of manual installation and intervention in the current processes.

Prior solutions of generating consumer relational marketing information from digital content transactions require more manual intervention. For example, a person would have to collect (usage or purchase) data from different content owners and/or content distributors and then determine a way to correlate them. Another example would be to survey (manually or electronically) the end-users about their digital content transactions. Or a prior solution would not be as comprehensive in that it would only represent data from a subset of content owners or distributors.

These solutions are more costly than the invention described here because they require alteration of the existing use or purchasing processes in order for usage data to be collected.

### BRIEF SUMMARY OF THE INVENTION

The present invention sets forth a system and method for a system and methods for generating information that is useful for consumer relational marketing purposes from a digital content transaction (or mediation) system.

This invention uses the ability to generate consumer relational marketing information from a database of transactions for digital content using a digital content mediator (“DCM”) to track the distribution of digital content. By using information from the transaction log, which can be either generated directly by the DCM server (typically sent to the payment engine for billing purposes) or can be output by the payment engine and combining with information from the content description database, a customer-content history database is created. Data mining techniques can then be used to derive the desired consumer relational marketing information from the customer-content history database. However, it is also possible to use data mining techniques across the databases (transaction log, content description database, and (optionally) the customer/client info DB) to obtain the desired consumer relational marketing data without first combining information into the customer-content history database.

The present invention will be more clearly understood when the following description is read in conjunction with the accompanying drawings.

### BRIEF DESCRIPTION OF THE DRAWINGS

FIG. 1 is a schematic diagram of an architecture of a basic digital content management system.

FIG. 2 is a schematic diagram of an architecture for a digital content management system that generates CRM Information in accordance with the present invention.

FIG. 3 shows a method for creating a content description database.

### DETAILED DESCRIPTION

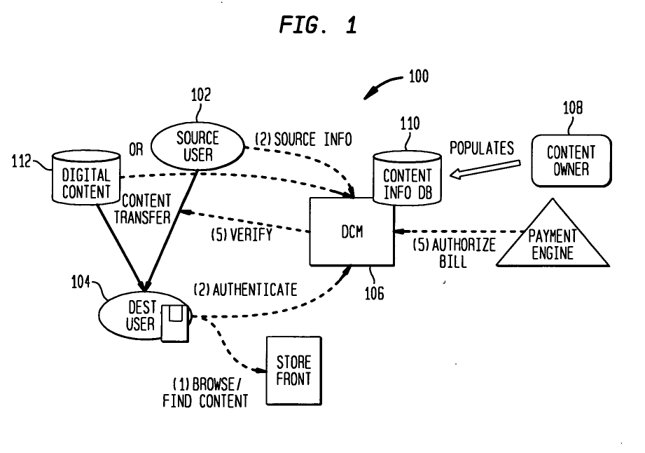

FIG. 1 is a schematic diagram of an architecture of a basic digital content management (“DCM”) System. A DCM system 100 enables peer-to-peer content distribution within a legitimate framework in which operators do not need to have first hand knowledge of the content elements. This could potentially enable an equivalent of ‘common carrier’ status in a digital content environment. Two sharing users, source user A 102 and destination user B 104, previously registered with a digital content mediator/manager (DCM) 106, find by some arbitrary method that they wish to exchange a piece of content, X. Destination user B requests a copy of X from source user A, which user A is willing to accept and so sends an acknowledgement back to user B. Both user A and user B register their interest in the content element X with the DCM 106. Note that in the general case there may be more than one sender (i.e. equivalent to user A) for a given reception. A Digital Content Mediator is described and illustrated, for example, in U.S. Patent Application Publication No. 2006/0173783, published on Aug. 3, 2006, entitled “System and Method for Authorized Digital Content Distribution”, which is incorporated herein by reference.

The DCM 106 performs a set of arbitrary tests against the transfer request (e.g. does user B have sufficient funds, does user A ‘officially’ have X, is it a Wednesday afternoon, the only time that user A is allowed to distribute content, and the like) and, assuming these tests are successful, the DCM sends an encryption key E to user A. This encryption key E is taken from a table of encryption key/hash pairs which may have been provided to the DCM by an external authority 108, not necessarily the content rights holder. In this case, the external agency would have to have access to the content, not the DCM.

User A 102 encrypts the content using they key provided by the DCM. User A then calculates a hash value over the encrypted form of the content E(X) and returns this value to the DCM. Since encryption key E is not known ahead of time, user B cannot know the value of the hash a priori and can only calculate it by performing Encryption/Hash Calculation steps. On checking the returned hash value against the hash value from the table, the DCM knows that user A does indeed have the content element X and it is in good condition. The DCM then instructs both user A and user B that the transfer may proceed.

The encrypted form of the content E(X) then is transferred from source user A to destination user B by means that are well known in the art. Once the content transfer has been completed user B ensures that the received content has been physically written storage. The content may be written to non-volatile storage to ensure that the content would not be irrevocably lost if the machine were to crash. User B then calculates a hash value over the received content and returns this value to the DCM. If this value matches the value previously provided to user A, then the transfer has been successful and the DCM updates whatever central records are appropriate, while also returning a decrypt key to user B to allow user B to decrypt the content. A record of the transfer is kept for a period of time such that if user's B device crashed during the period from obtaining the complete content to receiving the decrypt key and decrypting the content then user A and user B could request the key again without incurring additional charges.

It will be noted that the DCM never needed to ‘see’ the content. It only requires a set of encrypt key/hash pairs. If these pairs are generated by an external responsible authority then the organization running the DCM need never see or have knowledge of the content element. In a modification of the invention, if the key/hash pairs are consumed this would serve as a form of audit and tracking for the content rights holder and would also prevent possible attacks based in the re-use of key/hash pairs. Also, it is possible to create a hash value over the unencrypted form of the content and use that hash value for the identifying key as is known in the art.

In this basic system the content information database 110 only contains an anonymous content ID and content policy information, not content description information (e.g., type, title, artists, etc.) for each piece of content. Therefore, it would be very difficult to generate any useful consumer relational marketing information from the content information database.

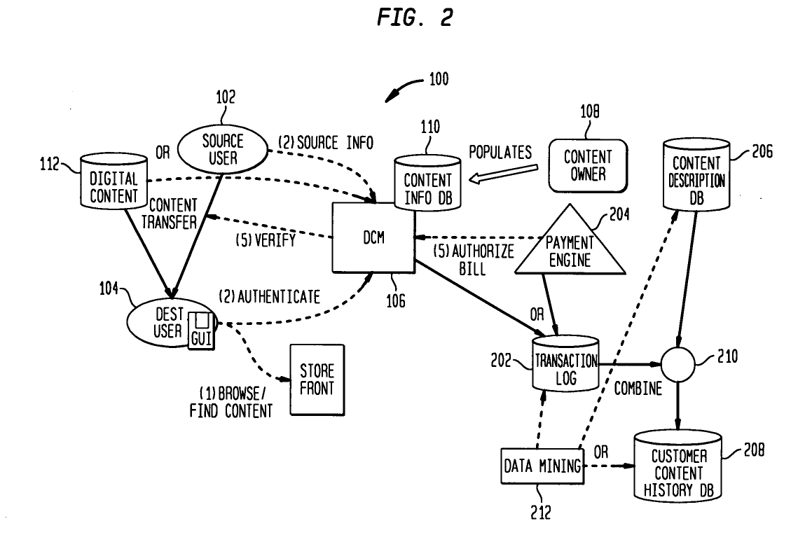

FIG. 2 illustrates a modification of the basic DCM system useful for generating consumer relational marketing information. Using information from a transaction log 202, which can be either generated directly by the DCM server (typically sent to a payment engine for billing purposes) or can be an output from the payment engine 204 and combining 204 the transaction log information with additional information from content description database 206, a Customer-Content history DB 208 can be generated.

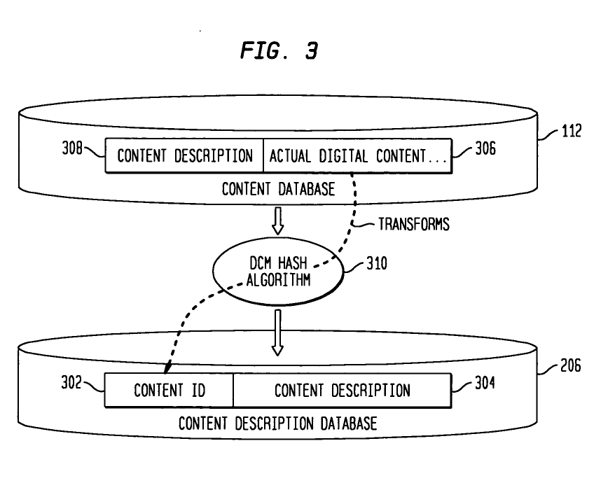

The Content Description database 206 contains an anonymous content ID 302 (generated the same way as the ID is generated in the Content Info DB 110) and a description of the content 304 (e.g,. type, title, artist, owner, etc.). FIG. 3 shows how the content description database 206 can be generated from the Digital Content DB 112, comprising an actual repository of the digital content 306 and a description of the content 308, usually maintained by the content owner, by using the same DCM hashing algorithm 310 that the DCM server employs to identify content. The content description DB 206 is usually populated/maintained by the content owner and there may be several of content description DBs (i.e. one for each content owner). However, the DCM service provider could decide (with agreement from all parties) to host and maintain the content description DB.

The combine operation 210 simply “matches” the anonymous content IDs recorded in the transaction logs with the anonymous IDs in the content description DB(s) to obtain a detailed list of digital content transactions. A customer/client information DB (that the payment engine would use) may need to be consulted to derive more information about the customer.

Data Mining 212 techniques can then be used to derive the desired consumer relational marketing information from the customer-content history DB 208. However, it is also possible to use data mining techniques across the databases (transaction log 202, content description database 206, and (optionally) the customer/client info DB) to obtain the desired consumer relational marketing data without first combining information into the customer-content history DB 208.

The content description database could be “virtual.” That is, it would not have to be created ahead of time and maintained, rather it could be generated on demand using the DCM hashing algorithm.

The present invention enables entities interested in obtaining consumer relational marketing information from digital content transactions to easily and automatically have the desired information generated (in near real-time if desired). Therefore, when compared to current methods for generating or collecting CRM data, it is less costly and simpler to implement, since no (or relatively few) new systems are required.

While there has been described and illustrated a system and method for generating consumer relational marketing information in a system for the distribution of digital content, it will be apparent to those skilled in the art that variations and modifications are possible without deviating from the broad teachings and spirit of the present invention which shall be limited solely by the scope of the claims appended hereto.

What is claimed is:

1. A system for generating customer relational marketing information in a system for the distribution of digital content comprising:
a digital content mediator for determining if a transfer of digital content from a source to a destination is permitted;
transformation log coupled to said digital content mediator for recording information about a transfer;
content description database for providing information regarding the content transferred; and
customer-content history database for receiving and combining the information about a transfer and the information regarding the content transferred for generating customer relational marketing information.

2. A method for generating customer relational marketing information in a system for the distribution of digital content comprising the steps of:
determining if a transfer of digital content from a source to a destination is permitted;
recording information about a transfer;
providing information regarding the content transferred; and
receiving and combining the information about a transfer and the information regarding the content transferred for generating customer relational marketing information.
